(19) United States
(12) Patent Application Publication
(10) Pub. No.: US 2016/0136030 A1
(43) Pub. Date: May 19, 2016

(54) MODELING APPARATUS FOR ASSISTING IN THE RECOVERY OF HAND, WRIST AND FOOT MOVEMENT

(71) Applicant: Gerson Lamenza Sholl da Silva, Rio de Janeiro (BR)

(72) Inventor: Gerson Lamenza Sholl da Silva, Rio de Janeiro (BR)

(21) Appl. No.: 14/902,544

(22) PCT Filed: Jul. 1, 2013
(86) PCT No.: PCT/BR2013/000233

§ 371 Date: Dec. 31, 2015

(51) Int. Cl. A61H 1/02; A61H 1/00

(52) U.S. Cl. CPC A61H 1/0218; A61H 1/008; A61H 1/0266; A61H 1/0285; A61H 1/0288

(57) ABSTRACT

The invention relates to the rehabilitation process of hands, wrists and feet by means of a specific apparatus, reaching 99% to 100% recovery thereof. The proposed process allows for the extension of the wrist and fingers including the thumb, combining all the movements performed by the hands as well as the feet.

The curves, deviations, separations and increased tension caused by this present process permits localized retraction of the fascia, muscles and affected tendons, as well as pain in various areas and anatomical regions of the hands, wrists and feet, which are worked simultaneously in all possibilities of the system, which attends to all needs.

### FIELD OF THE INVENTION

The present invention refers to the rehabilitation process of movement of the hands and feet injured by specific equipment, reaching 99% to 100% recovery thereof.

### BACKGROUND OF THE INVENTION

The current process allows for the extension of the wrist and fingers, including the thumb, combining all the movements performed by the hands, as well as the feet. The curves, deviations, clearances and increased tensions caused by this process permit localized retraction of fascia, muscles and affected tendons, as well as pain in various areas and anatomic regions of the hands, wrists and feet, since they are treated simultaneously in all possibilities of the apparatus, and are attended to in all their requirements.

Heretofore, hand rehabilitation procedures have been done using straight surfaces such as walls or tables, by pressing the hand against them to stretch the affected parts as far as possible, or with the well-known Canadian table which consists of putting a support in the table, in which the patient supports the arm, keeping the back of the hand on the contour of the support, thus stretching the palm and fingers that are attached by a glove. It is also used for hands and feet by countering the hand of the therapist or other manual techniques to stretch the hand or foot of the patient.

More recently, a plaster serial orthosis and/or thermoplastic material has been used which is molded in water at about 70° C., which takes the shape and dimension that allows a gradual stretching of the fingers of the hand and foot, wherein the molds are fixed on the fingers by means of tape.

The current inventive process provides several advantages, achieving a high, if not a total, recovery rate. By working with micro and macro system adjustments, better recovery is achieved in less time by working simultaneously with all affected limbs.

### SUMMARY OF THE INVENTION

The current invention comprises a process to rehabilitate the movements of the hands, wrists and feet by applying to these: a) a shaping device (1) which causes stretching of the fascia, muscles and tendons leading to recovery of the movements of the hands and wrists; b) adjacent parts, applied jointly or separately, and formed by individual extender boards, a “T” tourniquet and a press tourniquet, for the rehabilitation of individual fingers, with the most affected being achieved more swiftly; c) a foot shaping device which stretches the fascia, muscles and tendons which provide recovery of movement of the feet and toes.

### BRIEF DESCRIPTION OF THE DRAWINGS

FIG. 1 shows a schematic representation of the apparatus.

FIG. 2 shows the device mounted for use.

FIG. 3 illustrates the device applied to the dorsal region of the hand.

FIG. 4 illustrates the device applied to the dorsal region of the hand, which shows the fingers with folded first and second phalanges.

FIG. 5 shows the additional components that can be used in conjunction with the apparatus.

FIG. 6 demonstrates the device applied to the back of the hand, perceiving the wrist and fingers being elongated, as well as the differentiated treatment of the index finger.

FIG. 7 illustrates the application of a single extension plate to the index finger.

FIG. 8 shows a “T” tourniquet applied to the index finger.

FIG. 9 demonstrates the left hand being treated by the device with the application of an accessory piece, the press tourniquet.

FIG. 10 shows the foot shaper device.

### DETAILED DESCRIPTION OF THE INVENTION

The shaping apparatus (1) includes a beam (2) which comprises: a shaper (3) of the middle finger, shapers (4) of the ring and index fingers and shapers (5) of the little fingers, left and right, depending on the hand to be treated. The shaper (3) is fixed on the beam (2) while shapers (4) and (5) are adjustable allowing removing of the fingers as calculated by the required treatment, case by case, in this macro setting. The micro adjustment spacing of the fingers is made by an extender (6) fixed on the tips of the shapers (4), as well as an extender (7) fitted on the tip of the shapers (5). An “L” shaped part 8 is attached to the shaper 3 and is joined by articulation to a part 9, the latter also joined by articulation to a “Y” shaped piece 10. An “L” shaped part 11 is joined by articulation at one end to the “Y” shaped piece 10, which is fixed on the patient's forearm by an armband. A hole is provided in the other end of the “L” shaped part 11 serving as a way to secure a wrist extender 16. A threaded rod 12 is also joined by articulation to the “Y” shaped piece 10 at one of its ends. A shaper 14 is joined by articulation at one of its ends to the other end of the threaded rod 12, by means of the part 13. An adjuster 15 is provided at the other end of the shaper 14 serving to mount extenders.

Adjacent pieces are formed by individual extender boards (18) and (19), partially padded and applied to the fingers and secured by masking tape, causing a greater stretch, while a “T” tourniquet (20) is composed of the threaded rod (23) with soft padding material from the head (24) also padded where there are two strips of TheraBand attached (25) prior to attachment of the finger which leads to the desired tension with a twist of the tourniquet; while the press tourniquet (21) consists of a threaded rod (26) with adjusting head (27) and beam (28), embedded in the contour (29) where the rectangular screw runs (30) bearing the padded beam (31), being secured at one end on the padded beam (32).

The foot shaping apparatus (22) is formed by the support plates (33) and (34) fastened to each by adjustment controls (35) and (36) where there are adjustable extenders (37) and (38) at one end, determining the other two with a heel shaper (39). The plate (33) provides adjustable finger shapers (40), (41), (42) and (43).

The application of the shaping apparatus (1) and adjacent parts (18), (19), (20) and (21) at the hand as well as shaper (22) to the foot, to be treated, provide their components with the increased tension and deviation that facilitates stretching the fascia, muscles and affected tendons. The variety of injuries is countless, and each case is analyzed with the appropriate applied treatment for which the system has extreme and unique versatility. A shaping apparatus accompanies every need of treatment. Thus, providing stretching of the fingers, wrists and feet, in partial sets, providing the most varied combinations, but also produces calculated stretching in a comprehensive set, while providing separation, separately or together, as needed in each case.

The rehabilitation process of the movements of the hands and feet with the application of the apparatus allows the combining of other physiotherapy techniques with neural mobilization and muscular chain stretching positions to intensify treatment, and also allows its use in the horizontal position, as a straight surface, or in the vertical position while standing. The diversification of this process is such that it also allows for calculated individual traction of the fingers, wrists and feet, to combine desired traction and clearances of all affected limb components.

The apparatus as described is made of rigid material and padded with soft and durable material. The profile (11) is attached to a clamp (17) covering the forearm of the patient, which in turn is secured by masking tape that surrounds it. The support plates (33) and (34) of the foot shaper (22) are also internally padded to protect the foot to be treated.

Exemplifying the above are illustrative drawings, presented without restricting the character of the invention.

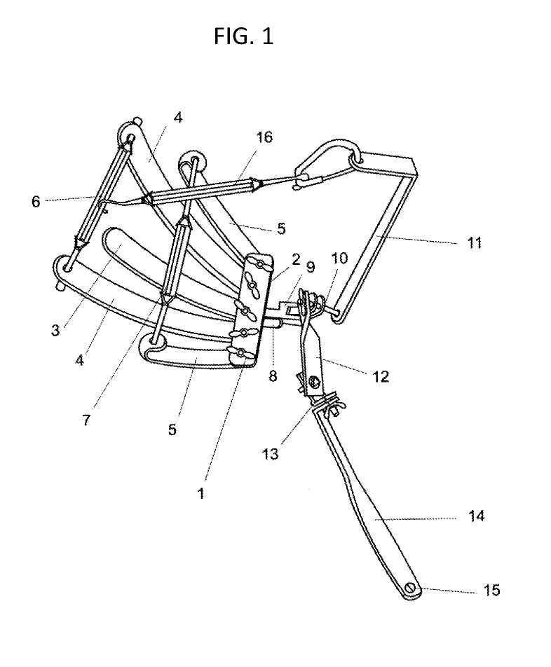

FIG. 1 shows schematically the device (1), where the piece 2 is the fixing bar of shapers (3), (4) and (5) in which macro deviation of the middle finger, ring finger, index finger and pinky finger are made, the fingers remaining attached to the apparatus by masking tape or any other disposable fastener, (6) is the extender which produces micro deviation of the ring and index fingers, (7) is the extender of the pinky fingers, (8) is an “L” profile that serves as a connecting bridge which is fixed to the fixing bar (2) together with the shaper (3) whose other end is joined by articulation by the part (9) which in turn articulates with the “Y” profile (10) that fixes itself to the “L” profile (11) and constitutes the central axis to a clamp, having at its other end the ability to articulate a wrist extender (16) that is also fixed on the extender itself (6). Together with the profile (10) and the profile (11) is an articulated threaded rod (12) whose end is an articulated “L” profile (13), which in turn articulates the thumb shaper (14) which has an adjustment (15) to attach extenders. Deviations are made with precision calculations proceeding to ulnar and radial deviations, and traction of the vertical or horizontal thumb.

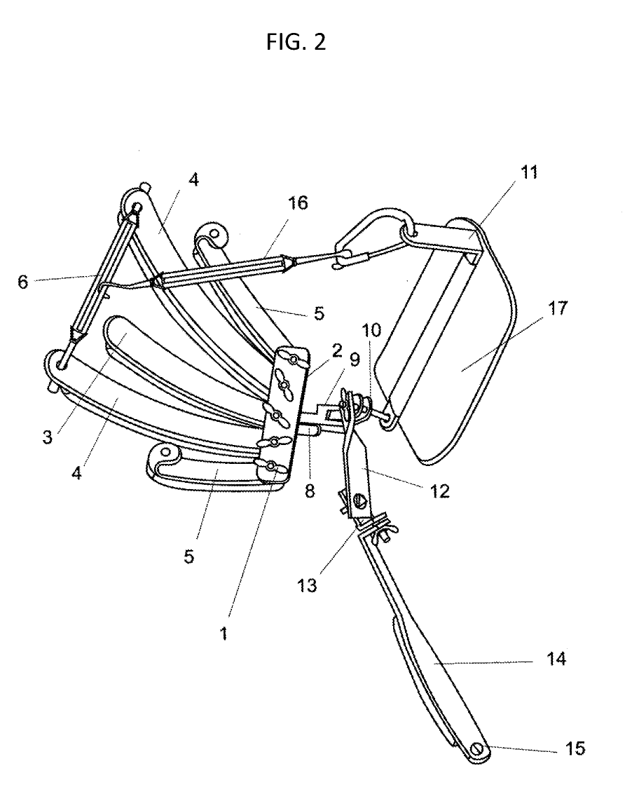

FIG. 2 shows the device (1) in use, where the shapers (3), (4), (5) and (14) are located, fully padded, as well as the profile (11) with the clamp (17). Further, we see the beam (2) where the profile (8) is attached which articulates the part (9) which is hinged at its other end of the “Y” profile (10) that attaches the profile (11) and threaded rod (12), (14) is the thumb shaper with the adjustment (15) and fixed to the profile (13) attached to the rod (12).

FIG. 3 shows the apparatus (1) applied to the dorsal region of the hand which is fixed to it by masking tape where (3) is the middle finger shaper (4) are shapers of the ring and index fingers (5) is the shaper of the little finger (6) is the extender of the ring and index fingers, (11) is the “L” profile covered with a protective tape, (14) is the thumb shaper and (16) is the wrist extender.

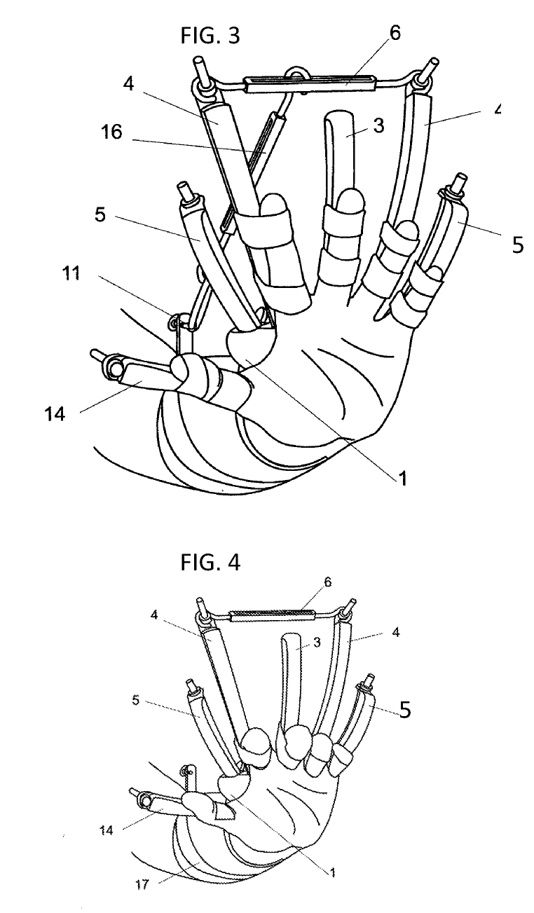

FIG. 4 illustrates the apparatus (1) applied to the dorsal region of the hand where (3), (4), (5) and (14) are shapers of the fingers, (17) is the clamp; covered by protective tape, and (6) is the extender of the ring and index fingers. The position shown in this drawing, presents the fingers with the first and second phalanges bent causing a greater elongation of the intrinsic hand muscles, simultaneously, which can be performed by isolating each finger, and uses masking tape, as needed, for each case.

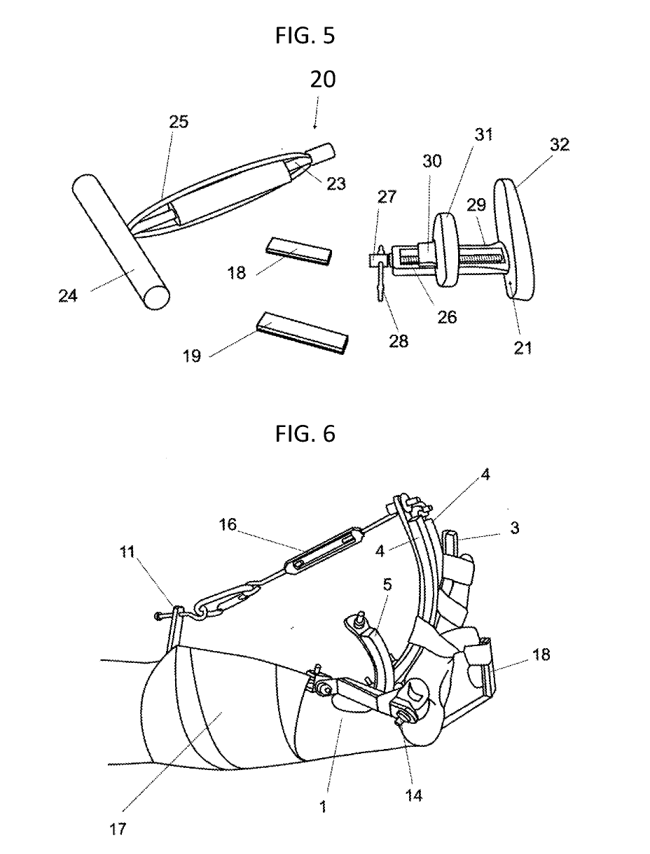

FIG. 5 shows the adjacent parts constituted by the individual extender plate (18), by the individual extender plate (19) by the “T” tourniquet (20) formed by the threaded rod (23) padded, of the head (24) and TheraBand tapes (25), and by the press tourniquet (21) formed by the threaded rod (26) with adjustment head (27) and the crossbar (28), of the contour (29) of the adjusting screw (30) and the padded crossbar.

FIG. 6 shows the apparatus (1) applied to the back of the hand where (3) the middle finger shaper is located, (4) and the shapers of the ring and index fingers, (11) is the “L” profile covered by the clamp fitted with protective tape, (16) is the wrist extender, (14) is the thumb shaper, (18) is the individual extender plate secured by masking tape and (5) the little finger shaper, when the device is applied to the right hand. In this drawing we perceive the wrist being elongated, as well as the fingers, and with differential treatment of the index finger by the application of the plate (18).

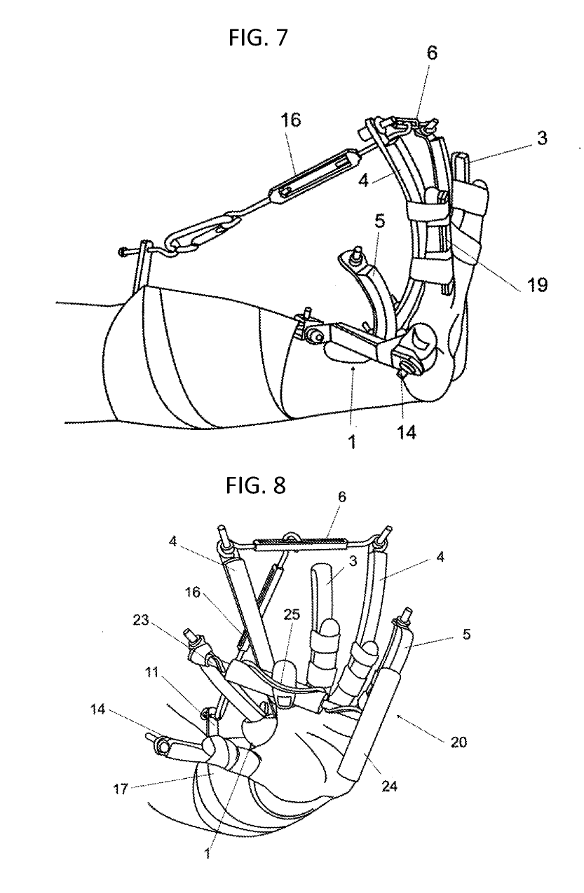

FIG. 7 illustrates the application of the individual extender plate (19) to the index finger, with the hand under tension in the apparatus (1) where (3) the middle finger shaper (4) the index finger shaper (5) and the shaper of the little finger are located when the device is applied to the right hand, (6) is the extender of the fingers, (16) the wrist extender and (14) the thumb shaper.

FIG. 8 shows the “T” tourniquet (20) applied to the finger where (23) the padded threaded rod is located, (24) is the head and (25) the TheraBand tape extension. In this figure the hand is under tension applied by the device (1) where (3) the middle finger shaper is located, (4) the shapers of the ring and index fingers, (5) the shaper of the little finger, (14) and the shaper of the thumb, (6) the extender of the ring and index fingers, (16) the wrist extender, (11) the “L” profile, (17) and the clamp attached to the forearm by protective tape.

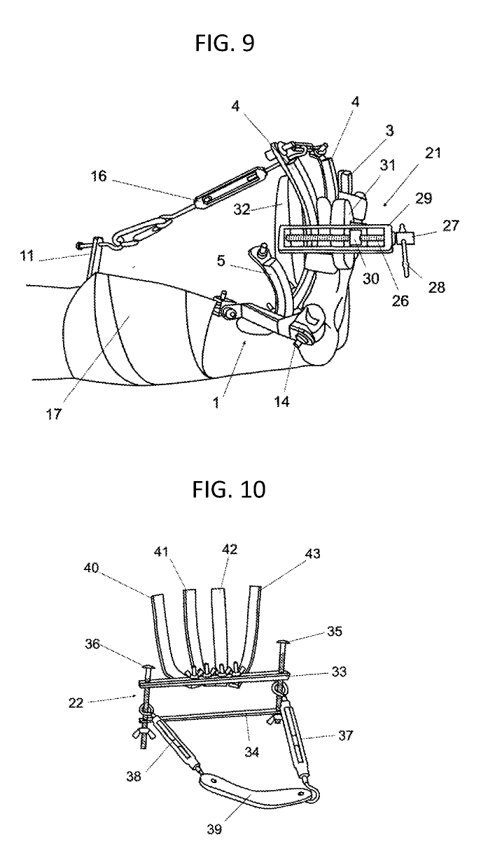

FIG. 9 shows the left hand being treated by the apparatus (1) with application of the adjacent part, the press tourniquet (21) where (26) the threaded rod is embedded in the contour (29), (27) the adjustment head with beam (28), (30) is the locking bolt (31) and (32) is the beam attached to the contour (29). Further, (3) is the middle finger shaper, (4) the shapers of the middle and index fingers, (5) the shaper of the little finger when the device (1) is applied to the right hand, (14) is the shaper of the thumb, (16) the wrist shaper (11) the “L” profile, (17) the clamp fitted to the forearm by protective tape.

FIG. 10 shows the foot shaping apparatus (22) where (33) and (34) are support plates attached by controls (35) and (36) the extenders being adjusted (37) and (38) which hold the heel shaper (39) at their extremities. Further, secured with the adjustment plate (33) are the finger shapers (40), (41), (42) and (43).

The process, as described, provides a high recovery rate of movement, if not full recovery. Further, the time required to obtain the desired results will be much less than previously required by treatments once the settings are all calculated, case by case, and provides a fully personalized treatment under full administrator control.

1. REHABILITATION PROCESS OF MOVEMENTS OF HANDS, WRISTS AND FEET. The process is comprised of applying them to shaping equipment which will provide macro and micro stretching of the fascia, muscles and tendons using: a) the shaper apparatus (1) containing the shaper (3) which is fixed to the beam (2) as well as the shapers (4) and (5) that are then articulated, while the shaper (14) with adjustment (15) is articulated to the profile (13), which is articulated to the threaded rod (12) which is articulated to the “Y” profile (10) which is a hinged part (9), articulated in turn to the “L” profile (8) which is fixed to the beam (2), while the macro wrist stretching is provided by the “L” profile (11) which is articulated to the profile (10), while the micro stretching is provided by the extenders (6), (7) and (16); b) the adjacent parts formed by individual extender boards (18) and (19) by the “T” tourniquet (20) and the press tourniquet (21); c) in the shaper of the feet (22).

2. REHABILITATION PROCESS OF MOVEMENTS OF HANDS, WRISTS AND FEET according to claim 1. The finger shapers (3), (4), (5) and (14) are padded with soft and durable material as well as the profile (11) covered by the clamp (17).

3. REHABILITATION PROCESS OF MOVEMENTS OF HANDS, WRISTS AND FEET according to claim 1. The process is comprised by the shaper device (1) and macro and micro adjustments for stretching the fascia, muscles and tendons of the hands and wrists.

4. REHABILITATION PROCESS OF MOVEMENTS OF HANDS, WRISTS AND FEET according to claim 1. The process is comprised by the shaper device (1) with deviations of ulnar and radial fingers and wrist, in addition to having vertical and horizontal traction.

5. REHABILITATION PROCESS OF MOVEMENTS OF HANDS, WRISTS AND FEET according to claim 1. It has individual (18) and (19) semi padded shaping plates.

6. REHABILITATION PROCESS OF MOVEMENTS OF HANDS, WRISTS AND FEET according to claim 1. It contains the “T” tourniquet (20) the threaded rod (23) padded, the head (24) also padded where the TheraBand tapes are located (25) which is driven by the tourniquet which performs the micro stretching of the affected fingers.

7. REHABILITATION PROCESS OF MOVEMENTS OF HANDS, WRISTS AND FEET according to claim 1. It is comprised of the press tourniquet (21) the threaded rod (26) with adjusting head (27) and beam (28), embedded in the contour (29) where the oblong screw runs (30) that comprises the beam (31) that is padded and attached to the padded beam (32).

8. REHABILITATION PROCESS OF MOVEMENTS OF HANDS, WRISTS AND FEET according to claim 1. It is comprised of the foot shaper apparatus (22) the bearing plates (33) and (34) semi padded and attached to the adjustment controls (35) where the extenders are set, in turn (37) and (38), counting these with the heel shaper (39), in addition to the plate (33) and adjustable finger shapers (40), (41), (42) and (43).

9. REHABILITATION PROCESS OF MOVEMENTS OF HANDS, WRISTS AND FEET according to claim 1. It comprises the hand shaping device (1) and the adjacent parts (18) (19) (20) and (21) together or separately considering each case of the affected members.

10. REHABILITATION PROCESS OF MOVEMENTS OF HANDS, WRISTS AND FEET according to claim 1. It comprises the foot apparatus (22) and the macro and micro stretching of the fascia, muscles and tendons of the feet.
